(19) United States
(12) Patent Application Publication
(10) Pub. No.: US 2006/0250411 A1
(43) Pub. Date: Nov. 9, 2006

(54) Apparatus and method to edit color profile

(76) Inventor: Hyun-soo Oh, Suwon-si (KR)

Correspondence Address: STANZIONE & KIM, LLP, 919 18TH STREET, N.W., SUITE 440, WASHINGTON, DC, 20006, US

(21) Appl. No.: 11/359,418

(22) Filed: Feb. 23, 2006

(30) Foreign Application Priority Data
May 3, 2005 (KR) 2005-37034

(51) Int. Cl. G09G 5/02

(52) U.S. Cl. 345/589

(57) ABSTRACT

An apparatus and method to edit a color profile. The apparatus includes an input and output profile setting unit to select an output profile and an input profile to be used to edit the output profile, a color region designation unit to designate a predetermined color region to be displayed on a color coordinate system, a color adjustment unit to adjust color of the designated color region by rotating a color angle on the color coordinate system, and a profile generation unit to generate a color profile corresponding to the adjusted color to be used as the selected output profile. Therefore, color region information of a favorable color or memory color corresponding to a human race or country unit can be stored in a database, and the favorable color can then be edited by a color region unit.

### CROSS-REFERENCE TO RELATED APPLICATIONS

This application claims the benefit under 35 U.S.C. § 119 of Korean Patent Application No. 10-2005-37034, filed on May 3, 2005, in the Korean Intellectual Property Office, the disclosure of which is incorporated herein in its entirety by reference.

### BACKGROUND OF THE INVENTION

1. Field of the Invention

The present general inventive concept relates to color profile editing, and more particularly, to an apparatus and method to edit a color profile with respect to a color area designated by a user.

2. Description of the Related Art

A color profile generation system includes a color printer for printing a color image, a measuring unit for measuring a test chart printed by the color printer, a profile generator for generating a color profile of the color printer from measured data of the test chart, and a profile editor for editing the color profile according to a user's request. The test chart is printed and measured for modeling an entire color gamut of the color printer, and the color profile including a color look-up table is generated to obtain device values (RGB or CMYK) corresponding to the measured data of the test chart according to an International Color Consortium (ICC) standard. Performance of the color profile is measured by printing a color chart or a standard image applied by the color profile and subjectively evaluating or comparing the color chart or the standard image to the data measured by the measuring unit. The profile is then edited if necessary. A conventional profile editing system can correct the entire color of the color profile of the color printer and correct a certain color of the color profile using color information such as brightness, contrast, and saturation.

However, the conventional color profile editing system does not provide an interface by which memory colors, such as skin color, sky color, and green color, that largely affect color recognition can be selectively corrected. Therefore, it is time-consuming, expensive, and very difficult to edit the color profile according to the user's request using the conventional profile editing system.

### SUMMARY OF THE INVENTION

The present general inventive concept provides an apparatus and method to edit a color profile by a color region unit.

Additional aspects and utilities of the present general inventive concept will be set forth in part in the description which follows and, in part, will be obvious from the description, or may be learned by practice of the general inventive concept

The foregoing and/or other aspects of the present general inventive concept may be achieved by providing a color profile editing apparatus, the apparatus including an input and output profile setting unit to select an output profile and an input profile to be used to edit the output profile, a color region designation unit to designate a predetermined color region to be displayed on a color coordinate system, a color adjustment unit to adjust a color of the designated color region by rotating a color angle on the color coordinate system, and a profile generation unit to generate a color profile corresponding to the adjusted color as the selected output profile.

The foregoing and/or other aspects of the present general inventive concept may also be achieved by providing a color profile editing apparatus, including a color region designation unit to store region information corresponding to one or more predetermined color regions, and to select at least one of the one or more predetermined color regions, a display unit to display the selected one of the one or more predetermined color regions on a predetermined color coordinate system, an adjustment unit to adjust a characteristic of the one or more predetermined color regions, and a profile generation unit to adjust a value of a color profile based on the adjusted characteristic of the displayed one of the one or more predetermined color regions.

The foregoing and/or other aspects of the present general inventive concept may also be achieved by providing a computer readable recording medium having embodied thereon a computer program to execute a graphic user interface to edit a color profile, the graphic user interface including an input and output profile setting unit to select an output profile and an input profile to be used to edit the output profile, a color region designation unit to designate a predetermined color region to be displayed on a color coordinate system, a color adjustment unit to adjust color of the designated color region by rotating a color angle on the color coordinate system, and a profile generation unit to generate a color profile corresponding to the adjusted color as the selected output profile.

The foregoing and/or other aspects of the present general inventive concept may also be achieved by providing a method of editing a color profile, the method including selecting an output profile to be edited and an input profile to be used to edit the output profile, and designating a predetermined color region to be displayed on a color coordinate system, adjusting a color of the designated color region by rotating a color angle on the color coordinate system, and generating a color profile corresponding to the adjusted color as the selected output profile.

The foregoing and/or other aspects of the present general inventive concept may also be achieved by providing a method of editing a color profile, the method including selecting one of one or more pre-stored color regions, displaying the selected one of the one or more pre-stored color regions, adjusting characteristics of the displayed one of the one or more pre-stored color regions, and adjusting values of a color profile based on the adjusted characteristics of the displayed one of the one or more pre-stored color regions.

The foregoing and/or other aspects of the present general inventive concept may also be achieved by providing a computer readable recording medium having embodied thereon a computer program to execute a method of editing a color profile, the method including selecting an output profile to be edited and an input profile to be used to edit the output profile, and designating a predetermined color region to be displayed on a color coordinate system, adjusting a color of the designated color region by rotating a color angle on the color coordinate system, and generating a color profile corresponding to the adjusted color as the selected output profile.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a color profile editing apparatus according to an embodiment of the present general inventive concept;

FIG. 2 is a diagram illustrating displaying elements of the color profile editing apparatus of FIG. 1;

FIG. 3 is a diagram illustrating a Hue-Saturation-Value (HVS) coordinate system;

FIG. 4 is a diagram illustrating an example of region information of a predetermined color region stored in a database in a color region designation unit of the color profile editing apparatus of FIG. 1; and

FIG. 5 is a flow chart illustrating a method of editing a color profile according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

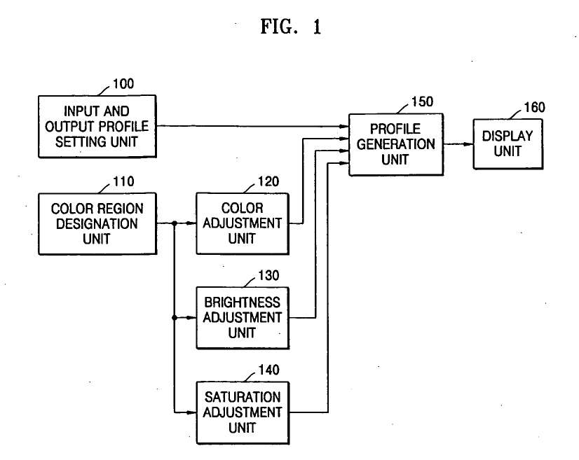

FIG. 1 is a block diagram illustrating a color profile editing apparatus according to an embodiment of the present general inventive concept. The color profile editing apparatus may be usable with an image forming apparatus such as a printer. The color profile editing apparatus includes an input and output profile setting unit 100, a color region designation unit 110, a color adjustment unit 120, a brightness adjustment unit 130, a saturation adjustment unit 140, a profile generation unit 150, and a display unit 160.

The input and output profile setting unit 100 sets or selects an output profile to be edited and an input profile to be used to edit output profile, and outputs the set values corresponding to the input and output profiles to the profile generation unit 150. The input profile is used to edit the output profile, and the input and output profile setting unit 100 can select a standard RGB profile corresponding to a predetermined standard color profile of a monitor as the input profile. The output profile designates a color profile to be edited or generated from the input profile, and the input and output profile setting unit 100 can set or select the color profile of the printer, which is obtained through a measurement using the input profile, as the output profile.

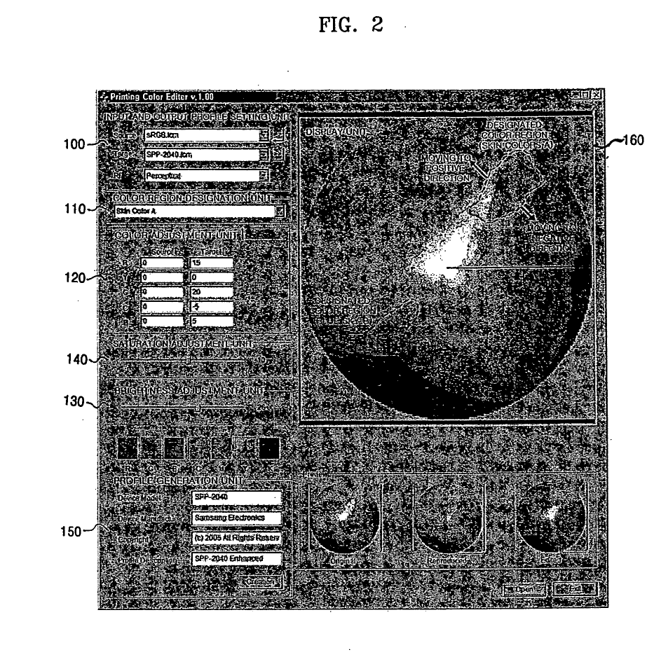

FIG. 2 is a diagram illustrating a possible arrangement of elements of the color profile editing apparatus of FIG. 1.

Referring to FIGS. 1 and 2, the input and output profile setting unit 100 selects a profile written in a “source” dialog box as the input profile, and selects a profile written in a “target” dialog box as the output profile. As described above, the input and output profile setting unit 100 can set or select the color profile of the monitor to be the input profile, and can set or select the color profile of the printer to be the output profile. Accordingly, the color profile of the monitor can be used to edit or generate the color profile of the printer so as to form an image using the edited color profile.

The color region designation unit 110 designates a predetermined color region on a color coordinate system, and outputs the designated predetermined color region to the color adjustment unit 120, the brightness adjustment unit 130, and the saturation adjustment unit 140.

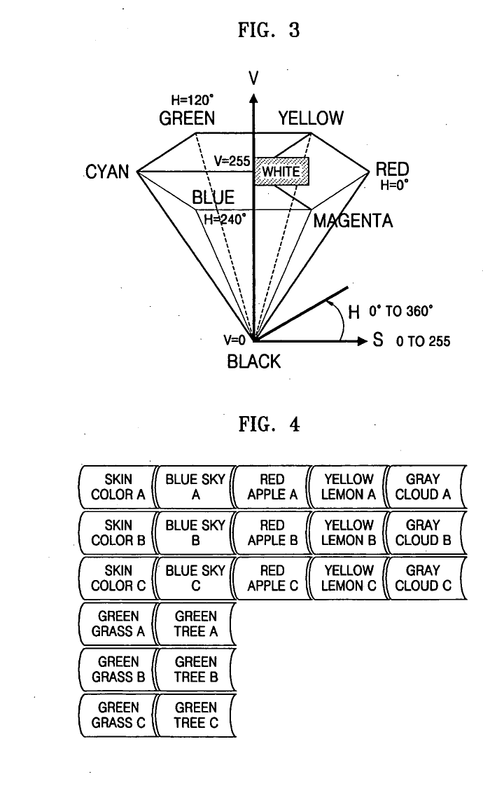

The color profile editing apparatus uses a Hue-Saturation-Value (HSV) coordinate system as the color coordinate system. FIG. 3 is a diagram illustrating the HSV coordinate system. Referring to FIG. 3, the HSV coordinate system is a coordinate system that represents hue (color) (H), value (brightness) (V), and saturation (S) on a three-dimensional space. The color (H) is changed by rotating a color angle of the color coordinate system within a range of 0° to 360°. The brightness (V) has brightness levels of 0 through 255. The saturation (S) has saturation levels of 0 through 255.

The color region designation unit 110 stores a database of region information with respect to one or more predetermined color regions. For example, the color region designation unit 110 can store memory color information including skin color, sky color, green color, red color, yellow color, and gray color information as the region information of the predetermined color regions in the database. The memory color information refers to a reproduction of a prior use of a certain color. In general, warm colors, such as red and yellow colors, can be reproduced exactly, and the memory color information can affect the uses of other colors.

FIG. 4 illustrates an example of the region information of the predetermined color regions stored in the database of the color region designation unit 110. Referring to FIG. 4, the memory color information can include the skin color, green color, red color, yellow color, and gray color information, and is set as the region information of the respective predetermined color region in advance, and stored in the database. For example, when the color region information corresponding to an Asian skin color is “SKIN COLOR A”, the region information of the Asian skin color can be set as follows.

Images of Asian population can be obtained using a still camera. The obtained images are then output by an image forming apparatus, such as a printer. The output images are measured by a spectrophotometer. The measured image data is converted into a histogram based on a number of pixels corresponding to each of the color angles of the HSV coordinate system. The histogrammed color angles that are not within an effective range of the Asian skin color are removed. The histogrammed color angles are then set as the region information of the predetermined color region corresponding to the Asian skin color.

If the color region information of a Caucasian skin color is “SKIN COLOR B,” and the color region information of an African skin color is “SKIN COLOR C,” the region information of the predetermined color regions corresponding to the Caucasian and African skin colors can also be set through the above described processes.

Referring to FIG. 2, the color region designation unit 110 can designate “SKIN COLOR A” input through a dialog box as the predetermined color region on the color coordinate system. As illustrated in FIG. 2, the predetermined color region designated by the color region designation unit 110 is displayed on the coordinate system on the display unit 160.

The color adjustment unit 120 controls a rotation of the color angle on the color coordinate system to adjust the color of the predetermined color region designated by the color region designation unit 110 and displayed on the display unit 160, and outputs the adjusted result to the profile generation unit 150. As illustrated in FIG. 2, the color adjustment unit 120 can rotate the color angle with respect to the predetermined region on the coordinate system in a positive direction (+) or a negative direction (−) to adjust the color.

The brightness adjustment unit 130 adjusts the brightness of the color region designated by the color region designation unit 110 and displayed on the display unit 160, and outputs the adjusted result to the profile generation unit 150. For example, as illustrated in FIG. 2, the brightness adjustment unit 130 can adjust the brightness of the designated color region using a brightness adjusting bar.

The saturation adjustment unit 140 adjusts the saturation of the color region designated by the color region designation unit 110 and displayed on the display unit 160, and outputs the adjusted result to the profile generation unit 150. For example, as illustrated in FIG. 2, the saturation adjustment unit 140 can adjust the saturation of the designated color region using a saturation adjusting bar.

Interpolation is performed for other regions except for the designated predetermined color region adjusted by the color adjustment unit 120, the brightness adjustment unit 130, and the saturation adjustment unit 140. That is, the color adjustment unit 120, the brightness adjustment unit 130, and the saturation unit 140 respectively interpolate values for the color, brightness, and saturation of the other regions based on the adjusted values of the designated predetermined color region.

The profile generation unit 150 generates or modifies the output profile corresponding to the color, the brightness, and the saturation of which are adjusted by the color adjustment unit 120, the brightness adjustment unit 130, and the saturation unit 140, respectively, and outputs the generated result to the display unit 160. That is, the profile generation unit 150 generates a new output profile as the modified output profile of the printer that is obtained by adjusting the color, the brightness, and the saturation of the set output profile according to information regarding the input and output profiles set by the input and output profile setting unit 100. The profile generation unit 150 can generate the new output profile as the modified output profile of the printer even in a case in which only one or two of the color, the brightness, and the saturation of the selected output profile are adjusted. For example, if only the color and the brightness of the selected output profile are adjusted, the profile generation unit 150 can generate the new output profile corresponding to the adjusted color and brightness, without adjusting the saturation.

The display unit 160 displays the output profile generated by the profile generation unit 150 on the color coordinate system. FIG. 2 illustrates an example of the output profile generated by the profile generation unit 150 displayed on the color coordinate system by the display unit 160. As illustrated in FIG. 2, the new output profile obtained by adjusting the color, brightness, and the saturation of the designated predetermined color region is displayed on the color coordinate system.

The present general inventive concept may be embodied as a graphic user interface, as illustrated in FIG. 2, in a general purpose digital computer by running a program from a computer usable medium.

A method of editing the color profile according to and embodiment the present general inventive concept will be described as follows.

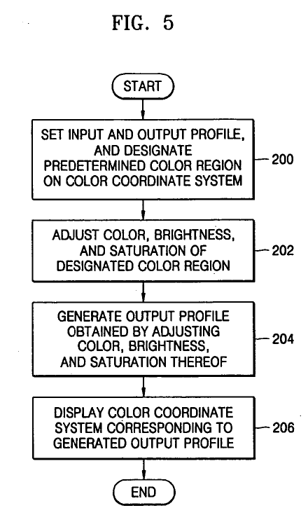

FIG. 5 is a flow chart illustrating the method of editing the color profile according to an embodiment of the present general inventive concept.

The output profile to be edited and the input profile to be used to edit the output profile are set (selected), and one of the predetermined color regions is designated to be displayed on the color coordinate system (S200).

When the input and output profiles are selected, the standard color profile of the monitor can be selected as the input profile and the color profile of the printer can be selected as the output profile.

The region information of the predetermined color regions is stored in advance in the database. For example, the memory color information including the skin color, sky color, green color, red color, yellow color, and gray color can be stored as the region information of the predetermined color regions in the database.

The color profile editing method can use the Hue-Saturation-Value (HSV) coordinate system as the color coordinate system.

The color, the brightness, and the saturation of the designated predetermined color region are then adjusted (S202).

The color can be adjusted by rotating the color angle in the positive (+) or negative (−) direction with respect to the designated predetermined color region on the color coordinate system.

The brightness can be adjusted using the brightness control bar, and the saturation can be adjusted using the saturation control bar.

The output profile corresponding to the adjusted color, brightness, and saturation is then generated (S204). That is, the values of the output profile are adjusted or modified to obtain a new output profile having values corresponding to the adjusted color, brightness, and saturation as the modified output profile.

The color coordinate system corresponding to the new output profile obtained by adjusting the color, brightness, and saturation is displayed (S206).

The method of editing the color profile according to the present general inventive concept can also be performed through codes/instructions/a program, which can be performed in a computer, and can be realized in a general-purpose digital computer, which operates the codes/instructions/program using a recording medium readable by the computer. The computer-readable recording medium includes a storage medium, such as a magnetic storing medium (for example, a ROM, a floppy disk, and a hard disk), an optical read-out medium (for example, a CD-ROM, DVD), and a carrier wave (for example, transmission through internet). In addition, the embodiments of the present general inventive concept can be realized as media including computer readable codes, and thus, a plurality of computer systems connected to each other by a network can separately process. The programs, codes, and code segments realizing the embodiments of the present general inventive concept can be construed easily by programmers in the art.

As described above, in apparatus and method to edit a color profile according to embodiments of the present general inventive concept, the color region information of a favorable color or a memory color corresponding to a human race or a country unit is stored in a database, and the favorable color can then be edited by a color region unit.

Furthermore, in an apparatus and method to edit a color profile according to embodiments of the present general inventive concept, a certain color region is edited as a favorable color region, and thus, printed output of the favorable color region can be obtained without affecting other colors.

In addition, printer color tables are edited by a color region unit in reproducing a printer color of a favorable color, and thus, time taken to generate a printer color profile can be reduced and performances of reproducing a color can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A color profile editing apparatus comprising:
an input and output profile setting unit to select an output profile and an input profile to be used to edit the output profile;
a color region designation unit to designate a predetermined color region to be displayed on a color coordinate system;
a color adjustment unit to adjust color of the designated color region by rotating a color angle on the color coordinate system; and
a profile generation unit to generate a color profile corresponding to the adjusted color as the selected output profile.

2. The apparatus of claim 1, further comprising:
a brightness adjustment unit to adjust brightness of the designated color region,
wherein the profile generation unit generates the color profile corresponding to the adjusted color and the adjusted brightness.

3. The apparatus of claim 2, further comprising:
a saturation adjustment unit to adjust saturation of the designated color region,
wherein the profile generation unit generates the color profile corresponding to the adjusted color, the adjusted brightness, and the adjusted saturation.

4. The apparatus of claim 3, further comprising:
a display unit to display the generated color profile on the color coordinate system.

5. The apparatus of claim 2, further comprising:
a display unit to display the generated color profile on the color coordinate system.

6. The apparatus of claim 1, further comprising:
a saturation adjustment unit to adjust saturation of the designated color region,
wherein the profile generation unit generates the color profile corresponding to the adjusted color and the adjusted saturation.

7. The apparatus of claim 6, further comprising:
a display unit to display the generated color profile on the color coordinate system.

8. The apparatus of claim 1, further comprising:
a display unit to display the generated color profile on the color coordinate system.

9. The apparatus of claim 1, wherein the input and output profile setting unit selects a standard color profile of monitor to be the input profile, and selects a color profile of a printer to be the output profile.

10. The apparatus of claim 1, wherein the color region designation unit comprises:
a database to store region information of the predetermined color region therein.

11. The apparatus of claim 10, wherein the database stores memory color information including skin color information, sky color information, green color information, red color information, yellow color information, and gray color information as the region information of the predetermined color region.

12. The apparatus of claim 1, wherein the color coordinate system comprises a Hue-Saturation-Value (HSV) coordinate system.

13. A color profile editing apparatus, comprising:
a color region designation unit to store region information corresponding to one or more predetermined color regions, and to select at least one of the one or more predetermined color regions;
a display unit to display the selected one of the one or more predetermined color regions on a predetermined color coordinate system;
an adjustment unit to adjust a characteristic of the one or more predetermined color regions; and
a profile generation unit to adjust a value of a color profile based on the adjusted characteristic of the displayed one of the one or more predetermined color regions.

14. The apparatus of claim 13, further comprising:
a color profile selecting unit to select to a color profile to be edited,
wherein the profile generation unit adjusts the value of the selected color profile based on the adjusted characteristic of the displayed one of the one or more predetermined color regions.

15. The apparatus of claim 13, further comprising:
a color profile selecting unit to select an input color profile of a monitor and an output color profile of a printer,
wherein the profile generation unit generates the adjusted value of the color profile using the input profile as the output profile.

16. The apparatus of claim 13, wherein the color region designation unit comprises:
a database to store the region information corresponding to the one or more predetermined color regions.

17. The apparatus of claim 13 wherein the adjustment unit comprises:
a color adjustment unit to adjust a color of the one or more of the predetermined color regions;
a brightness adjustment unit to adjust a brightness of the one or more of the predetermined color regions; and
a saturation adjustment unit to adjust a saturation of the one or more of the predetermined color regions.

18. The apparatus of claim 13, wherein the adjustment unit interpolates the adjusted characteristics of the displayed one of the one or more predetermined color regions to adjust characteristics of other regions of the color profile, and the profile generation unit adjusts the values of the color profile based on the adjusted characteristics of the displayed one of the one or more predetermined color regions and the adjusted characteristics of the other regions of the color profile.

19. The apparatus of claim 13, wherein the color profile adjusted by the profile generation unit comprises a color profile of a printer.

20. A computer readable recording medium having embodied thereon a computer program to execute a graphic user interface to edit a color profile, the graphic user interface comprising:
an input and output profile setting unit to select an output profile and an input profile to be used to edit the output profile;
a color region designation unit to designate a predetermined color region to be displayed on a color coordinate system;
a color adjustment unit to adjust color of the designated color region by rotating a color angle on the color coordinate system; and
a profile generation unit to generate a color profile corresponding to the adjusted color as the selected output profile.

21. A method of editing a color profile, the method comprising:
selecting an output profile to be edited and an input profile to be used to edit the output profile, and designating a predetermined color region to be displayed on a color coordinate system;
adjusting a color of the designated color region by rotating a color angle on the color coordinate system; and
generating a color profile corresponding to the adjusted color as the selected output profile.

22. The method of claim 21, further comprising:
adjusting a brightness of the designated color region after designating the predetermined color region, wherein the generating of the color profile comprises generating the color profile based on the adjusted color and the adjusted brightness.

23. The method of claim 22, further comprising:
adjusting a saturation of the designated color region after designating the predetermined color region, wherein the generating of the color profile comprises generating the color profile based one the adjusted color, the adjusted brightness, and the adjusted saturation.

24. The method of claim 23, further comprising:
displaying the generated color profiled on the color coordinate system.

25. The method of claim 22, further comprising:
displaying the generated color profile on the color coordinate system.

26. The method of claim 21, further comprising:
adjusting a saturation of the designated color region after designating the predetermined color region, wherein the generating of the color profile comprises generating the color profile based on the adjusted color and the adjusted saturation.

27. The method of claim 26, further comprising:
displaying the generated color profile on the color coordinate system.

28. The method of claim 21, further comprising:
displaying the generated color profile on the color coordinate system.

29. The method of claim 21, wherein in the selecting of the output profile to be edited and the input profile to be used to edit the output profile comprises:
selecting a standard color profile of a monitor to be the input profile; and
selecting a color profile of a printer to be the output profile.

30. The method of claim 21, wherein the designating of the predetermined color region comprises:
selecting region information stored in advance in a database corresponding to the predetermined color region.

31. The method of claim 30, wherein the selecting of the region information comprises:
selecting memory color information including one of skin color information, sky color information, green color information, red color information, yellow color information, and gray color information stored in the database.

32. The method of claim 21, wherein the color coordinate system comprises a Hue-Saturation-Value (HSV) coordinate system.

33. A method of editing a color profile, comprising:
selecting one of one or more pre-stored color regions;
displaying the selected one of the one or more pre-stored color regions;
adjusting characteristics of the displayed one of the one or more pre-stored color regions; and
adjusting values of a color profile based on the adjusted characteristics of the displayed one of the one or more pre-stored color regions.

34. The method of claim 33, wherein the adjusting of the values of the color profile comprises:
adjusting characteristics of regions of the color profile other than the displayed one of the one or more pre-stored color regions by interpolating the adjusted characteristics of the displayed one of the one or more pre-stored regions; and
adjusting the values of the color profile based on the adjusted characteristics of the displayed one of the one or more pre-stored color regions and the adjusted characteristics of the other regions.

35. A computer readable recording medium having embodied thereon a computer program to execute a method of editing a color profile, the method comprising:
selecting an output profile to be edited and an input profile to be used to edit the output profile, and designating a predetermined color region to be displayed on a color coordinate system;
adjusting a color of the designated color region by rotating a color angle on the color coordinate system; and
generating a color profile corresponding to the adjusted color as the selected output profile.
